(19) United States
(12) Patent Application Publication
(10) Pub. No.: US 2026/0163010 A1
(43) Pub. Date: Jun. 11, 2026

(54) Composite Current Collectors and Methods of Making and Using Thereof

(71) Applicant: GEORGIA TECH RESEARCH CORPORATION, Atlanta, GA (US)

(72) Inventors: Seung Woo LEE, Atlanta, GA (US); Minsu KIM, Atlanta, GA (US); Hyewon KANG, Atlanta, GA (US); Kyungmo KIM, Atlanta, GA (US)

(21) Appl. No.: 19/413,518

(22) Filed: Dec. 9, 2025

Related U.S. Application Data
(60) Provisional application No. 63/729,938, filed on Dec. 9, 2024.

(51) Int. Cl. H01M 4/62; H01M 4/04; H01M 4/66; H01M 10/052

(52) U.S. Cl. CPC H01M 4/628; H01M 4/0404; H01M 4/661; H01M 4/663; H01M 4/667; H01M 10/052

(57) ABSTRACT

Disclosed herein are composite current collectors as well as methods of making and using thereof.

### CROSS-REFERENCE TO RELATED APPLICATIONS

This application claims benefit of priority of U.S. Provisional Application No. 63/729,938, filed Dec. 9, 2024, which is hereby incorporated herein by reference in its entirety.

### BACKGROUND

Lithium-ion batteries are widely used in consumer electronics, electric vehicles, industrial energy-storage systems, and other applications due to their high energy density, long cycle life, and favorable performance characteristics. A typical lithium-ion cell includes a negative electrode, a positive electrode, a separator, and an electrolyte that enables the reversible intercalation and de-intercalation of lithium ions during charge and discharge.

Although lithium-ion technology has become well established, continued improvements in safety, energy density, power capability, lifespan, and manufacturing efficiency remain important. Conventional electrode materials, separators, electrolytes, and other cell components can suffer from limitations such as thermal instability, limited cycling durability, insufficient ionic conductivity, or mechanical degradation under demanding operating conditions. As the performance requirements for lithium-ion batteries increase, there is a need for improved components and materials that address these shortcomings and enable higher-performance, more reliable, and safer battery systems.

### SUMMARY

Copper (Cu) foil has long been the standard current collector (CC) for conventional lithium metal batteries (LMBs). However, the push towards higher energy density and dendrite-free lithium metal anodes (LMAs) demands a new approach to CC design. Traditional 2D Cu foil often results in porous and uneven lithium plating due to its intrinsic lattice mismatch with Li, leading to problematic dendritic growth. While 3D current collectors have shown promise in promoting planar Li metal growth, they typically suffer from being bulky and heavy, with scalability limitations.

Described herein is an innovative, mass-producible approach using non-solvent induced phase separation (NIPS) to fabricate a 3D porous, ultrathin (˜10 μm) composite current collector. This advanced CC combines a lithiophobic carbon nanotube (CNT) framework with uniformly dispersed copper nanoparticles (CuNPs). The CNT framework offers significant advantages over traditional 2D Cu foil, being lightweight, flexible, and mechanically robust. The lithiophobic nature of the CC directs lithium nucleation to the CuNPs, resulting in uniform and dense Li plating. This design not only enhances energy density but also significantly improves long-term cyclic stability in LMBs. By leveraging this CC design, we move closer to achieving more efficient, scalable, and sustainable LMB technology, contributing to the broader goals of decarbonization and a transition to renewable energy sources.

### DESCRIPTION OF DRAWINGS

FIGS. 1A-1B. Preparation of NIPS-based CuNP-CNT CCs. (1A) A schematic illustration of the process used to prepare NIPS-based CuNP-CNT CCs. (1B) Digital images of the NIPS-based CuNP-CNT CCs.

FIGS. 2A-2C. Characterization of CuNP-CNT CCs with Varied PES Concentrations. (2A) Porosity enhancement in the CuNP-CNT CCs achieved by altering the PES concentration in the solvent mixture. (2B) Comparative mass loading of the CuNP-CNT CCs relative to traditional Cu foil. (2C) SEM analysis of CuNP-CNT CCs60, showcasing its microstructural details.

FIGS. 3A-3B. Comparative Li Plating Morphologies on CuNP-CNT CCs. (3A) Digital photographs of 4 mAh/cm² Li plated on Cu foil (left) and CuNP-CNT (right). (3B) SEM images of 0.5, 1, 2, 4 mAh/cm² Li plated on CuNP-CNT.

FIGS. 4A-4C. Electrochemical Performance and Stability of CuNP-CNT CCs Compared to Traditional Cu Foil. (4A) Nyquist plots of CuNP-CNT CCs|Li foil and Cu foil|Li foil half-cells. (4B) Deposition potential curves for Li deposition on CuNP-CNT CCs and Cu foil. (4C) Cycling performance of CuNP-CNT60|Li foil and Cu foil|Li foil half-cells at 1 mA·cm⁻² and 1 mAh·cm⁻² .

FIGS. 5A-5B. LMB Full Cell Performance Using CuNP-CNT CCs-based and commercial Li Anodes. (5A) Cycling stability test of Li-CuNP-CNT CCs (4 mAh·cm⁻²)|NMC811 and commercial Li (7 mAh·cm⁻²)|NMC811 cells, tested at a rate of 0.5 C. (5B) Charge-discharge voltage profiles from the cycling stability test.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features.

Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise.

As used herein, the terms “optional” or “optionally” mean that the subsequently described event or circumstance may or may not occur and that the description includes instances where said event or circumstance occurs and instances where it does not.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims, which follow, reference will be made to a number of terms that shall be defined herein.

For the terms “for example” and “such as,” and grammatical equivalences thereof, the phrase “and without limitation” is understood to follow unless explicitly stated otherwise.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range.

For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

It will be understood that, although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or a section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

As used herein, the term “substantially,” in, for example, the context “substantially identical” or “substantially similar” refers to a method or a system, or a component that is at least about 80%, at least about 85%, at least about 90%, at least about 91%, at least about 92%, at least about 93%, at least about 94%, at least about 95%, at least about 96%, at least about 97%, at least about 98%, at least about 99%, or about 100% by similar to the method, system, or the component it is compared to.

“Nanoparticle”, as used herein, refers to any entity having a diameter of less than 1 micron (μm). Typically, particles have a greatest dimension (e.g., diameter) of 1000 nm or less. In some embodiments, particles have a diameter of 300 nm or less. In some embodiments, nanoparticles have a diameter of 200 nm or less. In some embodiments, nanoparticles have a diameter of 100 nm or less.

“Mean particle size,” as used herein, generally refers to the statistical mean particle size (diameter) of the particles in a population of particles. The diameter of an essentially spherical particle may be referred to as the physical or hydrodynamic diameter. The diameter of a non-spherical particle may refer preferentially to the hydrodynamic diameter. As used herein, the diameter of a non-spherical particle may refer to the largest linear distance between two points on the surface of the particle. Mean particle size can be measured using methods known in the art, such as dynamic light scattering or electron microscopy.

“Monodisperse” and “homogeneous size distribution,” are used interchangeably herein and describe a plurality of liposomal nanoparticles or microparticles where the particles have the same or nearly the same diameter or aerodynamic diameter. As used herein, a monodisperse distribution refers to particle distributions in which 75, 76, 77, 78, 79, 80, 81, 82, 83, 84, 85, 86, 86, 88, 89, 90, 91, 92, 93, 94, 95% or greater of the distribution lies within 85, 80, 75, 70, 65, 60, 55, 50, 45, 40, 35, 30, 25, 20, 15, or 10% of the mass median diameter or aerodynamic diameter.

While aspects of the present invention can be described and claimed in a particular statutory class, such as the system statutory class, this is for convenience only, and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

Provided herein are methods of fabricating a porous composite film comprising a population of metal nanoparticles dispersed within a matrix comprising carbon nanotubes and a matrix polymer. These methods can comprise; preparing a mixture comprising the population of metal nanoparticles, carbon nanotubes, and matrix polymer dissolved or dispersed in a first solvent; depositing a film of the mixture on a substrate; and contacting the film with a second solvent.

In some embodiments, the mixture comprises a slurry.

In some embodiments, the first solvent is a suitable solvent for dissolving or dispersing the population of metal nanoparticles, carbon nanotubes, and matrix polymer. In some embodiments, the first solvent comprises a blend of a primary solvent and a secondary solvent. In some embodiments, the primary solvent comprises N-methyl-2-pyrrolidone. In some embodiments, the secondary solvent comprises THF. In some embodiments, the first solvent is volatile, miscible in the second solvent, or a combination thereof.

In some embodiments, the second solvent comprises a non-solvent for the metal nanoparticles, the carbon nanotubes, and the matrix polymer. In some embodiments, the second solvent comprises an alcohol, such as a C1-C6 alcohol. In some examples, the second solvent can comprise methanol, ethanol, propanol, isopropanol, n-butanol, 2-butanol, isobutanol, tert-butanol, or combinations thereof. In certain embodiments, the second solvent can comprise ethanol.

In some embodiments, the method further comprises removing at least a portion of the first solvent from the film prior to contacting the film with the second solvent.

In some embodiments, the film is contacted with the second solvent under conditions effective to allow for first solvent/second solvent exchange within the film.

In some embodiments, the second solvent comprises an alcohol such as ethanol.

By way of example and without wishing to be bound by theory, composites can be prepared from a slurry comprising the population of metal nanoparticles, the carbon nanotubes, and the matrix polymer. The first solvent can comprise a solvent (or a blend of a primary solvent and a secondary solvent) which are good solvents for (i.e., suitably dissolve and/or disperse) the population of metal nanoparticles, the carbon nanotubes, and the matrix polymer. In some examples, the first solvent can comprise a blend of N-methyl-2-pyrrolidone (NMP) and tetrahydrofuran (THF). The addition of THF can help achieve a uniform mix, which is important for maintaining the structural integrity of the film during the casting process and preventing unwanted phase separation caused by improper solvent and non-solvent exchanges.

The mixture can then be cast on a substrate. Optionally, a portion of the first solvent (in this example a portion of the THF) can be evaporated. The film can then be immersed in EtOH. This replaces the residual first solvent (NMP and THF) in the film with EtOH, thereby solidifying the film's structure while preserving its flexibility and mechanical robustness.

In some embodiments, the metal nanoparticles comprise lithiophilic metal nanoparticles. Lithiophilic metal particles include metallic particles that exhibit favorable wetting, nucleation, or interfacial affinity for lithium, such that the particles promote uniform lithium deposition, improved lithium transport, or stable lithium-metal interfaces within a battery component. Lithiophilic behavior may arise from the intrinsic surface energy of the metal, the formation of lithium-rich alloys, or the ability of the metal surface to chemically or electrochemically interact with lithium under operating conditions. Examples of lithiophilic metal nanoparticles include, for example, nanoparticles comprising aluminum, gold, silver, magnesium, zinc, tin, indium, gallium, antimony, bismuth, cobalt, manganese, zinc, copper, and alloys or mixtures thereof, as well as metals capable of forming lithium alloys such as silicon, germanium, and lead.

In certain embodiments, the metal nanoparticles comprise silver nanoparticles, cobalt nanoparticles, manganese oxide nanoparticles, tin nanoparticles, zinc nanoparticles, copper nanoparticles, copper oxide nanoparticles, zinc oxide nanoparticles, tin oxide nanoparticles, or silicon dioxide nanoparticles. In certain embodiments, the metal nanoparticles comprise copper nanoparticles

In some embodiments, the population of metal nanoparticles exhibits a monodisperse particle size distribution.

In some embodiments, the population of metal nanoparticles exhibit an average particle size, as measured by scanning electron microscopy (SEM), of at least 5 nm (e.g., at least 10 nm, at least 15 nm, at least 20 nm, at least 25 nm, at least 30 nm, at least 35 nm, at least 40 nm, at least 45 nm, at least 50 nm, at least 55 nm, at least 60 nm, at least 65 nm, at least 70 nm, at least 75 nm, at least 80 nm, at least 85 nm, at least 90 nm, at least 95 nm, at least 100 nm, at least 150 nm, at least 200 nm, at least 250 nm, at least 300 nm, at least 350 nm, at least 400 nm, at least 450 nm, at least 500 nm, at least 550 nm, at least 600 nm, at least 650 nm, at least 700 nm, at least 750 nm, at least 800 nm, at least 850 nm, at least 900 nm, or at least 950 nm). In some embodiments, the population of metal nanoparticles exhibit an average particle size, as measured by scanning electron microscopy (SEM), of less than 1 micron (e.g., 950 nm or less, 900 nm or less, 850 nm or less, 800 nm or less, 750 nm or less, 700 nm or less, 650 nm or less, 600 nm or less, 550 nm or less, 500 nm or less, 450 nm or less, 400 nm or less, 350 nm or less, 300 nm or less, 250 nm or less, 200 nm or less, 150 nm or less, 100 nm or less, 95 nm or less, 90 nm or less, 85 nm or less, 80 nm or less, 75 nm or less, 70 nm or less, 65 nm or less, 60 nm or less, 55 nm or less, 50 nm or less, 45 nm or less, 40 nm or less, 35 nm or less, 30 nm or less, 25 nm or less, 20 nm or less, 15 nm or less, or 10 nm or less).

The population of metal nanoparticles exhibit an average particle size ranging from any of the minimum values described above to any of the maximum values described above. For example, population of metal nanoparticles can exhibit an average particle size, as measured by SEM, of from 5 nm to less than 1 micron (e.g., from 5 nm to 500 nm, from 5 nm to 250 nm, from 5 nm to 150 nm, from 5 nm to 100 nm, or from 5 nm to 80 nm, from 25 nm to 500 nm, from 25 nm to 250 nm, from 25 nm to 150 nm, from 25 nm to 100 nm, or from 25 nm to 80 nm, from 50 nm to 500 nm, from 50 nm to 250 nm, from 50 nm to 150 nm, from 50 nm to 100 nm, or from 50 nm to 80 nm).

Any suitable carbon nanotubes (prepared by any suitable method or obtained from a commercial source) can be used. The carbon nanotubes can comprise single-walled carbon nanotubes, multiwalled carbon nanotubes, or a combination thereof. In some embodiments, the carbon nanotubes can comprise multiwalled carbon nanotubes.

In some cases, the carbon nanotubes can have an average diameter of at least 10 nm (e.g., at least 20 nm, at least 30 nm, or at least 40 nm). In some cases, the carbon nanotubes can have an average diameter of 50 nm or less (e.g., 40 nm or less, 30 nm or less, or 20 nm or less). In certain embodiments, the carbon nanotubes can have an average diameter ranging from any of the minimum values described above to any of the maximum values described above. For example, the carbon nanotubes can have an average diameter of from 10 nm to 50 nm (e.g., from 10 nm to 30 nm, or from 20 nm to 50 nm).

In some cases, the carbon nanotubes can have an average length of at least 50 nm (e.g., at least 100 nm, at least 200 nm, at least 300 nm, at least 400 nm, at least 500 nm, at least 600 nm, at least 700 nm, at least 800 nm, at least 900 nm, at least 1 μm, at least 5 μm, at least 10 μm, or at least 15 μm). In some cases, the carbon nanotubes can have an average length of 20 μm or less (e.g., 15 μm or less, 10 μm or less, 5 μm or less, 1 μm or less, 900 nm or less, 800 nm or less, 700 nm or less, 600 nm or less, 500 nm or less, 400 nm or less, 300 nm or less, 200 nm or less, or 100 nm or less).

In certain embodiments, the carbon nanotubes can have an average length ranging from any of the minimum values described above to any of the maximum values described above. For example, the carbon nanotubes can have an average length of from 50 nm to 20 μm (e.g., from 200 nm to 20 μm, or from 500 nm to 10 μm).

In some cases, the carbon nanotubes can comprise unfunctionalized carbon nanotubes. In other embodiments, the carbon nanotubes can comprise sidewall functionalized carbon nanotubes. Sidewall functionalized carbon nanotubes are well known in the art. Suitable sidewall functionalized carbon nanotubes can be prepared from unfunctionalized carbon nanotubes, for example, by creating defects on the sidewall by strong acid oxidation. The defects created by the oxidant can subsequently converted to more stable hydroxyl and carboxylic acid groups. The hydroxyl and carboxylic acid groups on the acid treated carbon nanotubes can then couple to reagents containing other functional groups (e.g., amine-containing reagents), thereby introducing pendant functional groups (e.g., amino groups) on the sidewalls of the carbon nanotubes. In some embodiments, the carbon nanotubes can comprise hydroxy-functionalized carbon nanotubes, carboxy-functionalized carbon nanotubes, amine-functionalized carbon nanotubes, or a combination thereof.

In some embodiments, the matrix polymer comprises polyethersulfone (PES), polyethylene, polypropylene, polytetrafluoroethylene (PTFE), Polyvinylidene fluoride (PVDF), styrene butadiene rubber, a tetrafluoroethylene hexafluoro ethylenic copolymer, a tetrafluoroethylene hexafluoropropylene copolymer (FEP), a tetrafluoroethylene perfluoroalkyl vinyl ether copolymer (PFA), ethylene-tetrafluoroethylene copolymer (ETFE resin), polychlorotrifluoroethylene resin (PCTFE), a propylene-tetrafluoroethylene copolymer, an ethylene-chlorotrifluoroethylene copolymer (ECTFE), an ethylene-acrylic acid copolymer, or a blend thereof. In certain embodiments, the matrix polymer comprises polyethersulfone (PES).

Also provided herein are composites prepared by the methods described herein. In some embodiments, the composite can in the form of a porous film having a thickness of from 2.5 microns to 25 microns, such as about 10 microns.

In some embodiments, these composites can be used as porous, 3D current collectors for use in fabricating an electrodes.

Accordingly, also provided herein are electrodes (e.g., anodes) comprising these current collectors. In some embodiments, the electrode can further comprise Li metal plated on the current collector. In some embodiments, the current collector enhances the uniformity and/or density of the lithium plating.

Also provided herein are electrochemical cells (e.g., lithium metal batteries) comprising an electrode described herein. In some embodiments, the current collector (and by extension the electrode) enhances the cyclic stability of the electrochemical cell.

Having generally described this invention, a further understanding can be obtained by reference to certain specific examples which are provided herein for purposes of illustration only and are not intended to be limiting unless otherwise specified.

### EXAMPLES

The invention will be described in greater detail by way of specific examples. The following examples are offered for illustrative purposes, and are not intended to limit the invention in any manner. Those of skill in the art will readily recognize a variety of non-critical parameters which can be changed or modified to yield essentially the same results.

### Example 1. Lightweight, Flexible 3D Porous CuNP-CNT Composite Current Collectors for High Energy Density Lithium Metal Batteries: A Nonsolvent-Induced Phase Separation Approach

### Summary

Traditional lithium (Li) metal anodes (LMAs) paired with 2-dimensional (2D) copper (Cu) foils often suffer from undesirable Li dendrite growth, which not only degrades battery performance but also poses significant safety risks, including potential fire hazards from short-circuits triggered by dendrite penetration. To address these challenges, 3D current collectors (CCs) have been introduced, offering increased surface area, reduced local current density, and a more uniform electric field to effectively mitigate dendrite formation. However, creating a lightweight, thin, and mechanically robust 3D CC that can be mass-produced remains a significant practical challenge.

Described herein is the development and validation of a mass-producible, lightweight, and ultra-thin 3D porous composite CC for Li metal batteries (LMBs) using the non-solvent-induced phase separation (NIPS) method. The NIPS technique leverages a solution of polymer, carbon nanotubes (CNTs), and Cu nanoparticles (CuNPs), where the lower-density CNTs align with the precipitating polymer, while the higher-density CuNPs are repelled. This process results in a 3D framework where the CNTs and polymer act as a scaffold, securely anchoring the agglomerated CuNPs and ensuring their even distribution across the membrane. This uniquely structured, thin, and lightweight CC (CuNP-CNT) addresses the limitations of traditional 2D copper foils, which often lead to uneven lithium deposition and dendritic growth, thereby compromising the safety, stability, and energy density of LMBs.

The CuNP-CNT CC promotes dense and uniform lithium plating, even at higher Li loadings (up to 4 mAh/cm²), effectively preventing dendrite formation. Electrochemical testing demonstrated that the CuNP-CNT composite CC exhibits significantly lower charge-transfer resistance and superior cycling stability compared to traditional Cu foils, achieving a Coulombic efficiency (C.E.) of 98.3% over 300 cycles. Further validation in full-cell configurations paired with LiN_{0.8}Mn_{0.1}Co_{0.1}O₂ (NMC811) cathodes showed that the CuNP-CNT composite CC provided enhanced performance and cycling stability, maintaining a C.E. of 99.3% over 200 cycles, while traditional Cu foil-based cells exhibited rapid capacity decay. Overall, this innovative CuNP-CNT CC offers a scalable and effective solution for improving the energy density, safety, and longevity of LMBs, positioning it as a highly promising candidate for next-generation energy storage systems.

### Introduction

LMBs are heralded as a transformative energy storage technology due to their exceptional theoretical energy density. However, the widespread commercialization of LMBs has been impeded by critical safety and stability issues, particularly those associated with LMAs. Traditional 2D Cu foils, commonly employed as current collectors, often lead to uneven and dendritic lithium deposition. This irregular deposition arises from uneven electric fields across the CC's surface, which encourage the formation of sharp, needle-like lithium projections known as dendrites. These dendrites pose severe risks, as they can penetrate the battery separator, leading to internal short circuits, which in turn can trigger thermal runaway, fires, or even explosions. Moreover, the extensive growth of dendrites consumes large amounts of electrolyte, accelerating battery degradation and leading to premature failure.

The limitations of 2D Cu foils are further exacerbated by their limited interfacial surface area and high intrinsic weight, both of which negatively impact the energy densities of LMBs. To address these challenges, researchers have explored the use of 3D CCs as a superior alternative. 3D structures provide increased surface area and reduce local current density, thereby delaying dendrite formation in accordance with Sand's law. Additionally, these 3D CCs help create a more uniform electric field, promoting even lithium deposition and stabilizing the solid electrolyte interphase (SEI) layer, which is crucial for accommodating volumetric changes during lithium plating and stripping cycles.

Despite the benefits of 3D metallic CCs, they are often encumbered by significant weight and volume, limiting their practical application. To overcome these drawbacks, researchers have developed lightweight, thin 3D current collectors using carbon-based materials, such as CNTs and graphene. These materials offer distinct advantages, including low weight, flexibility, and high mechanical strength. However, their relatively low electronic conductivity and lithiophobic nature have limited their effectiveness as CCs in LMBs.

To address these limitations, the integration of 3D porous carbon structures with lithiophilic metals like silver (Ag), tin (Sn), and Cu has emerged as a promising solution. This approach enhances the cyclic stability of anodes while reducing the overall size, weight, and cost of the batteries. However, achieving a controlled thickness close to 10 μm and developing scalable manufacturing processes for such CCs have remained challenging.

In response to these challenges, described herein is a scalable NIPS method to manufacture ultra-thin (˜10 μm), highly porous, and lightweight CCs composed of CuNP aggregates within CNT frameworks. This innovative approach significantly improves the safety, stability, and performance of LMBs, addressing the technical barriers associated with traditional 2D CCs. By providing a scalable solution, this work represents a substantial advancement in the development of next-generation energy storage systems, bringing us closer to the widespread adoption of LMBs in various high-demand applications.

To achieve our objectives, we focus on four strategic goals:
1. Synthesizing CuNP-CNT composites
2. Analyzing Li plating morphology
3. Evaluating the electrochemical performance of CuNP-CNT CC
4. Assessing the electrochemical performance of LMBs
   Success in these areas could propel CuNP-CNT composites to transform LMB manufacturing, enhance battery performance and advance Li battery technology towards greater viability and sustainability for widespread application.

### Technical Approach

Described herein are methods that facilitate the fabrication of a mass-producible, lightweight, and thin 3D porous composite CC composed of CuNP aggregates within CNT frameworks using the NIPS method. The goal is to validate this CC's applicability and demonstrate its ability to enhance the cyclic performance and energy density of LMBs.

### Synthesis of CuNP-CNT Composites

To develop a flexible, lightweight, ˜10 μm-thick 3D structured anode composed of CuNPs, multi-walled CNTs (MWCNTs), and polyethersulfone (PES), we first formulated a carefully balanced slurry. This mixture included CuNPs, MWCNTs, and PES, dissolved in a solvent blend of N-methyl-2-pyrrolidone (NMP) and tetrahydrofuran (THF). The use of THF was critical in achieving a uniform mix, which aided in maintaining the structural integrity of the film during the casting process and preventing unwanted phase separation caused by improper solvent and non-solvent exchanges.

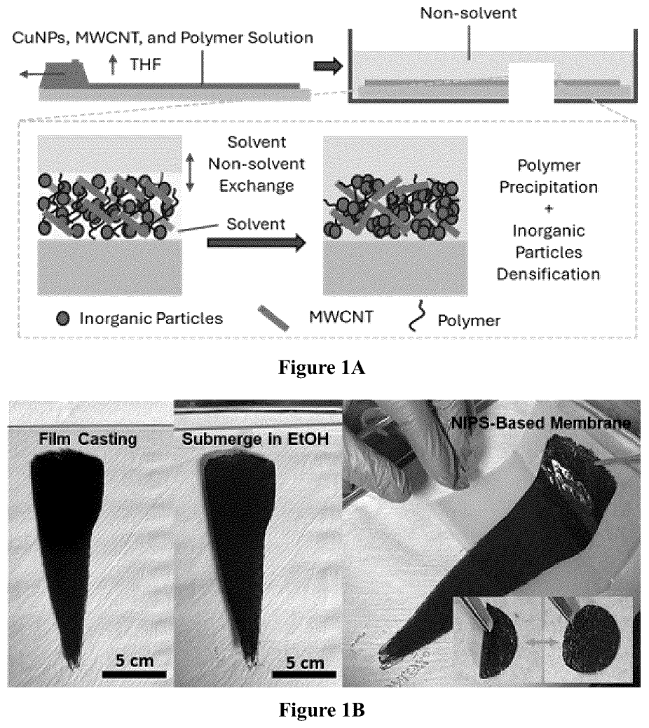

The slurry was then evenly spread onto a glass substrate using a tape-casting technique with a doctor blade, precisely controlling the film's thickness to approximately 10 μm (FIG. 1A). Following a brief air-drying period to partially evaporate the THF, the film was immersed in an ethanol (EtOH) bath (FIG. 1B). This step facilitated the replacement of residual NMP with EtOH, solidifying the film's structure while preserving its flexibility and mechanical robustness.

Three variations of the anode were synthesized-designated as CuNP-CNT50, CuNP-CNT60, and CuNP-CNT70-by adjusting the PES concentration in the solvent mixture to ratios of 1:50, 1:60, and 1:70, respectively, while maintaining a consistent NMP weight ratio of 9:91. The CuNPs and MWCNTs were blended into the PES solution at a ratio of 8:1:1 by weight, ensuring a homogeneous distribution throughout the slurry.

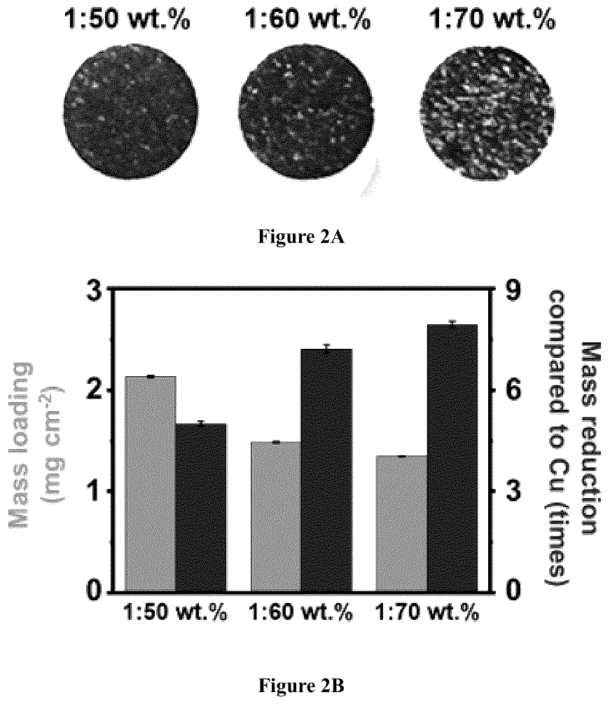

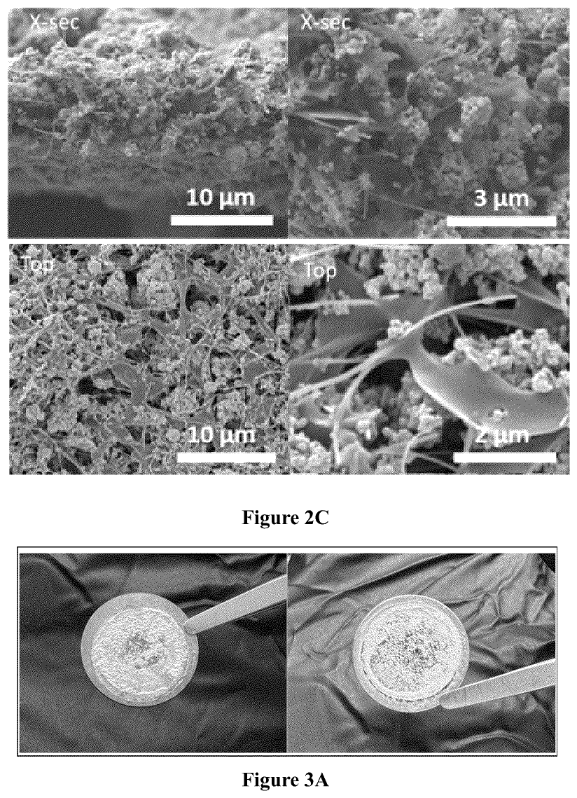

These variations in solvent concentration significantly increased the porosity of the CCs (FIG. 2A), resulting in reduced mass loadings of 2.1, 1.3, and 1.2 mg cm⁻², respectively—a substantial reduction compared to traditional Cu foils (FIG. 2B). Among these, CuNP-CNT60 was selected for subsequent experiments due to its optimal balance between mechanical properties and mass loading. Scanning electron microscopy (SEM) analysis revealed that CuNP-CNT 60 exhibited smaller, more uniform pores, approximately 1 μm in diameter (FIG. 2C). Additionally, SEM images demonstrated that during the NIPS process, the lower-density CNTs followed the precipitating PES, while the higher-density CuNPs were repelled, resulting in the formation of a 3D framework where the MWCNTs and PES acted as a scaffold, securely anchoring the agglomerated CuNPs and ensuring their even distribution across the membrane.

This precise control over material composition and the casting process yielded a novel 3D structure that significantly enhances the performance and efficiency of LMBs by leveraging the synergy between the conductive CuNPs and the structurally reinforcing MWCNTs embedded in a porous PES matrix. This innovation represents a substantial advancement in the development of high-performance, lightweight current collectors for next-generation energy storage solutions.

### Morphological Analysis of Li Plating

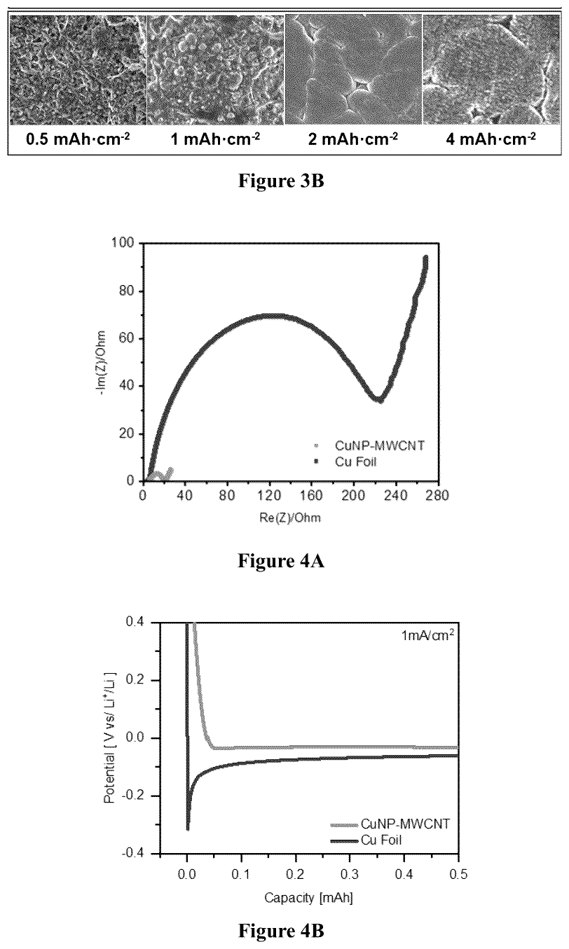

To explore the Li plating mechanism, we plated varying amounts of Li (0.5, 1, 2, 4 mAh/cm²) onto the CuNP-CNT CC. First, the optical image of 4 mAh/cm² Li-plated Cu CC shows a more irregular and vertical plating morphology, whereas the CuNP-CNT CCs exhibits a flatter and more horizontal characteristic (FIG. 3A). Detailed SEM images of the Li plating morphology reveal that Li metal is densely plated on the CuNP_Composite. Up to 1 mAh/cm² of Li plating, the CNT network is clearly visible, indicating that Li is densely concentrating on the CuNPs (FIG. 3B). When 2 mAh/cm² of Li is plated onto the composite, the CNT network is no longer visible, suggesting that the pores are filled. At 2 and 4 mAh/cm² , the Li plating morphology is dense and uniform, indicating dendrite-free Li plating on the CuNP-CNT CCs. This suggests that the dense Li, concentrated on the CuNPs, continues to form even after the pores are fully filled.

### Electrochemical Performance of NIPS-based Composite Current Collector

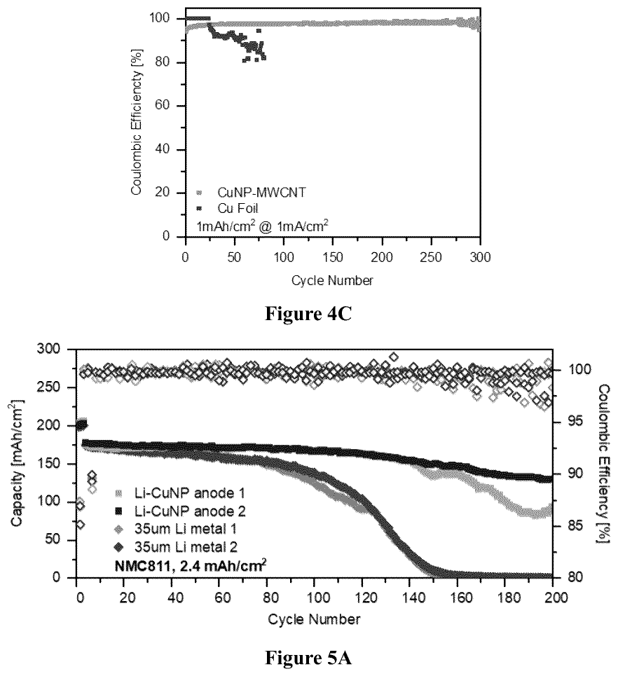

The Li deposition behavior on the Cu and composite current collectors was investigated in 2032 half-cells with a Li foil as the counter electrode. An electrolyte composed of 1,3-dioxolane (DOL), 1,2-dimethoxyethane (DME) (volume ratio: 1:1) and 1 M LiTFSI with 1 wt. % Li nitrate (LiNO₃) was used. The charge-transfer resistances (Rct) of CuNP-CNT60 were significantly lower at 22 Ω cm², compared to 230 Ω cm² for traditional Cu foil (FIG. 4A), evidenced by the markedly smaller diameter of the semi-circle in the impedance spectra of CuNP-CNT compared to that of Cu foil. The improved charge-transfer kinetics is attributed to the 3D structure of the composites, which accommodates greater electrochemical surface area (ECSA) and strengthens the overall integrity and material properties of the CuNP-CNT composite. These structural advantages result in lower nucleation potential (Vnec, reflected by the sharp tip curves in the deposition potential curves) and mass-transfer potential (Vmass, reflected by the steady curves) for Li deposition, which are critical for enhancing electrochemical stability (FIG. 4B). Specifically, Vnec for CuNP-CNT 60 was measured at 4 m V and Vmass at 3 mV. In contrast, for Cu foil, these values were higher, at 34 m V for Vnec and 8 m V for Vmass, further emphasizing the superior performance of the composite materials in reducing barriers to efficient Li-ion nucleation and movement during battery operation.

To characterize the plating/stripping performance of 3D CC, a CuNP-CNT 60|Li foil coin cell was operated at a current density of 1 mA·cm⁻² and an areal capacity of 1 mAh·cm⁻² , and maintained a high average Coulombic efficiency of 98.3% over 300 cycles (FIG. 4C). In contrast, a Cu foil|Li foil cell quickly experienced a short-circuit at the 80th cycle under the same conditions. These findings demonstrate that CuNP-CNT CCs provide superior plating/stripping performance and cycling stability, making them more suitable for LMBs than traditional Cu foils. This enhanced performance, consistent with the high Coulombic efficiencies observed in earlier tests, underlines the efficacy of CuNP-CNT CCs in improving the reliability and longevity of LMB

### Assessing the Electrochemical Performance of the LMBs

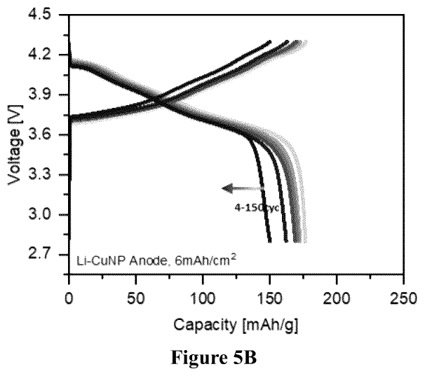

To validate the practical utility of the CuNP-CNT CCs, we tested full cells utilizing this composite and Cu foil as anodes, paired with a NMC 811 cathode (mass loading: 12mg·cm- 2 ). The electrolyte used comprised of a 1:1 volume ratio of ethylene carbonate (EC) and diethyl carbonate (DEC), supplemented with 1 M Li bis(fluorosulfonyl)imide (LiFSI) and 10 wt. % FEC. The current collectors were plated with 4 mAh·cm⁻² of Li. The configurations, Li-CuNP-CNT CCs|NMC811 and commercial Li (7 mAh·cm⁻²)|NMC811, underwent galvanostatic charge-discharge testing at a rate of 0.5 C (FIG. 5). The Li-CuNP-CNT CCs|NMC811 cell demonstrated robust performance, maintaining stable cycling for 200 cycles with a C.E. of 99.3%. In contrast, the commercial Li|NMC 811 cell exhibited rapid capacity decay, achieving a C.E. of only 90.4% after 80 cycles. The premature degradation of the commercial Li|NMC 811 cell was primarily attributed to the formation of loosely deposited Li on the Cu foil, which exacerbated dead-Li growth and accelerated electrolyte consumption.

### Impacts

The broader impact of this research lies in its transformative potential to accelerate the commercialization of high-energy-density LMBs. By pioneering the development of lightweight, thin, 3D porous CCs composed of CuNPs and CNTs using a scalable NIPS method, this study addresses critical challenges in energy storage, including dendrite formation, battery safety, energy density, and manufacturing scalability.

This innovative approach to CC design not only enhances the electrochemical performance and cyclic stability of LMBs but also significantly reduces the overall size, weight, and cost of batteries. The versatility of the NIPS process allows for the incorporation of various nanoparticles and polymers, making this technology highly adaptable and attractive for a wide range of applications, including electric vehicles, portable electronics, and grid storage, where high energy density, safety, and cost-effectiveness are paramount.

Moreover, the scalable nature of the NIPS process paves the way for mass production, facilitating the widespread adoption of next-generation LMBs. This research marks a pivotal advancement toward more sustainable and efficient energy storage solutions, with profound implications for the development of clean energy technologies and the global effort to reduce carbon emissions. The ability to tailor the process for different materials further broadens the impact of this work, making it a versatile platform for advancing various energy storage technologies.

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative compounds, components, compositions, and method steps disclosed herein are specifically described, other combinations of the compounds, components, compositions, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

1. A method of fabricating a porous composite film comprising a population of metal nanoparticles dispersed within a matrix comprising carbon nanotubes and a matrix polymer, the method comprising;
preparing a mixture comprising the population of metal nanoparticles, carbon nanotubes, and matrix polymer dissolved or dispersed in a first solvent;
depositing a film of the mixture on a substrate; and
contacting the film with a second solvent.

2. The method of claim 1, wherein the metal nanoparticles comprise lithiophilic metal nanoparticles.

3. The method of claim 1, wherein the metal nanoparticles comprise silver nanoparticles, cobalt nanoparticles, manganese oxide nanoparticles, tin nanoparticles, zinc nanoparticles, copper nanoparticles, copper oxide nanoparticles, zinc oxide nanoparticles, tin oxide nanoparticles, or silicon dioxide nanoparticles.

4. (canceled)

5. The method of claim 1, wherein the population of metal nanoparticles exhibits a monodisperse particle size distribution.

6. The method of claim 1, wherein the population of metal nanoparticles exhibits an average particle size of from 50 nm to 500 nm, as measured by electron microscopy.

7. (canceled)

8. The method of claim 1, wherein the matrix polymer comprises polyethersulfone (PES), polyethylene, polypropylene, polytetrafluoroethylene (PTFE), Polyvinylidene fluoride (PVDF), styrene butadiene rubber, a tetrafluoroethylene hexafluoro ethylenic copolymer, a tetrafluoroethylene hexafluoropropylene copolymer (FEP), a tetrafluoroethylene perfluoroalkyl vinyl ether copolymer (PFA), ethylene-tetrafluoroethylene copolymer (ETFE resin), polychlorotrifluoroethylene resin (PCTFE), a propylene-tetrafluoroethylene copolymer, an ethylene-chlorotrifluoroethylene copolymer (ECTFE), an ethylene-acrylic acid copolymer, or a blend thereof.

9. (canceled)

10. The method of claim 1, wherein the mixture comprises a slurry.

11. The method of claim 1, any wherein the first solvent is a suitable solvent for dissolving or dispersing the population of metal nanoparticles, carbon nanotubes, and matrix polymer.

12. The method of claim 1, wherein the first solvent comprises a blend of a primary solvent and a secondary solvent.

13. The method of claim 12, wherein the primary solvent comprises N-methyl-2-pyrrolidone.

14. The method of claim 12, wherein the secondary solvent comprises THF.

15. The method of claim 1, wherein the first solvent is volatile, miscible in the second solvent, or a combination thereof.

16. The method of claim 1, wherein the second solvent comprises a non-solvent for the metal nanoparticles, the carbon nanotubes, and the matrix polymer.

17. The method of claim 1, wherein the method further comprises removing at least a portion of the first solvent from the film prior to contacting the film with the second solvent.

18. The method of claim 1, wherein the film is contacted with the second solvent under conditions effective to allow for first solvent/second solvent exchange within the film.

19. The method of claim 1, wherein the second solvent comprises an alcohol such as ethanol.

20. A composite prepared by the method of claim 1.

21. (canceled)

22. A porous, 3D current collector for use in fabricating an electrode comprising the composite defined by claim 20.

23. An electrode comprising the current collector of claim 22.

24. (canceled)

25. An electrochemical cell comprising the electrode defined by claim 23.

26. (canceled)

27. (canceled)

28. (canceled)
